(19) United States
(12) Patent Application Publication
(10) Pub. No.: US 2021/0157927 A1
(43) Pub. Date: May 27, 2021

(54) NETWORKED APPLICATION ORCHESTRATION

(71) Applicant: BRITISH TELECOMMUNICATIONS PUBLIC LIMITED COMPANY, London (GB)

(72) Inventors: Simon BEDDUS, London (GB); Claudia CRISTINA, London (GB); Fadi EL-MOUSSA, London (GB)

(21) Appl. No.: 17/059,356

(22) PCT Filed: Apr. 25, 2019
(86) PCT No.: PCT/EP2019/060664

§ 371 Date: Nov. 27, 2020

(30) Foreign Application Priority Data
May 31, 2018 (EP) 18175413.6

(51) Int. Cl. G06F 21/57; H04L 29/08; H04L 12/24; H04L 29/06; G06F 8/61

(52) U.S. Cl. CPC G06F 21/577; H04L 67/16; H04L 41/0813; G06F 2221/033; H04L 63/20; G06F 8/61; H04L 67/32

(57) ABSTRACT

Network-based applications and virtualized components are deployed according to a security analysis of the infrastructure to be used and applications to be run on it. A specification of requirements (201) is analysed (211), together with potential devices (212) and network nodes (213), to determine an appropriate level of security to be applied, and a deployment specification of applications, services, security countermeasures, and networks is prepared that will satisfy the customer requirement and with known characteristics and vulnerabilities of the services. This analysis is used to generate a deployment specification (22), and finally the actual control of an orchestrator (23) to deliver the service. The deployed system can be continually monitored to ensure that the service continues to operate within requirements. Should an incident such as a network attack or failure occur the system is re-analysed against the original requirements and re-configured or repaired. This invention helps defend against opportunities for attack from malevolent forces presented by increasingly complex services and especially micro-services, by building in security to their design.

This invention relates to automation of deployment of network based applications and Network Function Virtualisation (NFV) components based on the wider security analysis of deployment infrastructure.

The delivery of network operations and services is becoming more automated. More complex services present new opportunities for attack from malevolent forces. It is therefore important that security be at the core of how these services are composed.

Modern NFV and network-based applications are planned, deployed and operated as individual systems. When combined, such systems may have functional dependencies on one another, for example a web server may depend on a switch, but these dependencies may only become apparent when a device fails and the service stops.

Examples include the systems described in United States application US2018/046457, and European application EP3016016, in which an operating system is created or reconfigured to match the requirements of a previously-specified containerised application.

This “stovepipe” approach to service delivery can result in security dependency issues whereby the omission of a security countermeasure in one upstream component can result in security attacks on other components downstream. The planning of such countermeasures is commonly performed only as an afterthought, once the functional design has been decided. Commonly, the security overlay is performed by a limited number of very busy specialists that can lead to omission or unnecessary duplication of security countermeasures across a system. It may also result in modification of the initial functional design in a way which is detrimental to its performance or user interface. An alternative approach is described in US2016/156661, which design a system around an security profile identified for the existing infrastructure. However, security profiles are commonly specified for worst-case situations, but may be over-cautiously specified for a particular application, resulting in less-than-optimal performance in other respects.

The converse may also occur, in which the predetermined security profile has to be relaxed or over-ridden in a specific respect, for example because a secure network connection is not available, or because the application is intended to identify security threats, or to test new and uncertified devices, or has to run non-standard software, in which case it is desirable that other aspects of the security profile be enhanced to compensate.

According to the invention, there is provided a method of deploying applications and virtualised network functions to meet a service specification in which a security profile is assigned, and a plurality of candidate configurations of network resources, devices, applications and functions are assessed for ability to meet the service specification, and in which a security analysis is performed of the candidate network configurations, devices and applications to be deployed to implement the service, a configuration is selected, and the network resources, devices, applications and functions adapted to meet the assigned security profile prior to deployment. After deployment, the selected configuration may be monitored to ensure that the system remains within requirements. On detection of a network attack or failure a new security profile is generated, the configuration can be re-analysed against the new security profile, and the network configurations, devices and applications re-configured to meet the new security profile.

Embodiments of the invention provide a way of deploying network-based applications and NFV components based on a wider security analysis of the deployment infrastructure. Embodiments of the invention adapts the environment in which the container is to work, as well as configuring the containerised application itself, to meet a security specification suitable for both the application and the environment. The user's requirements can be defined in the form of a set of services, security expectations, and physical and economic constraints. In particular, users can request individual security scores both for elements of the service and for the complete service. The process decomposes such a service set and analyses the services (applications & NFV apps), and potential devices and network nodes used to deliver that service set, to determine what updates are required to make the service safe, and to satisfy any other requirements such as user preferences based on cost or whether the resources are under the control of external parties. A deployment designer can then create a new deployment specification of applications, services and networks that will satisfy, or come closest to satisfying, the customer specification.

The invention may be embodied in software comprising computer program code for controlling a general-purpose computer to perform the steps of the process.

The invention also extends to a computer system including a processor and a memory storing computer program code for performing the steps of the process of the invention, and to a computer program element comprising computer program code to, when loaded into a computer system and executed thereon, cause the computer to perform the steps of the process.

The use of “Container” technology to run services and applications is becoming increasingly common due to its flexibility, packing density, portability across systems, and ease of deployment and configuration. Container technology allows multiple applications and their libraries to be run with a degree of isolation on a common operating system, but each operates inside its own isolated environment with only the software components and libraries it requires, packaged in a standardised way. Using containers results in smaller applications (a few tens of Megabytes), which are quicker to download and start up, and provides a much higher packing density of applications per physical server than virtualisation or indeed the traditional operating system and application model, thereby using less of the system's resources. This approach allows applications to be more efficient, lightweight, and portable between different operating systems.

Embodiments of the present invention provide a computer-implemented process for controlling a containerisation orchestrator, comprising the steps of the method of the invention by:
a) selecting a candidate application for containerised deployment to a device
b) retrieving application software for running the application
c) analysing the application software for vulnerabilities
d) analysing the selected container deployment configuration
e) assessing operational parameters of the device
f) comparing the operational parameters of the device and the container deployment configuration with vulnerabilities identified in the candidate application software, to determine if they are compatible with a predetermined risk score
g) if it is determined that the candidate application is not compatible with the risk score, re-assessing the candidate application for compatibility if adapted with an enhanced security provision
h) if such compatibility is identified, controlling the orchestrator to containerise and deploy the candidate application software on the device.

If compatibility is not identified, the orchestrator may not deploy the candidate application software, and instead the analysis steps can be repeated using a different candidate application.

An Infrastructure Management system may be used to control one or more orchestration and network management systems to deploy services using respective deployment agents in the network resources and devices. A user's specification for end-to-end service can be input in the form of applications, network links, devices and security constraints, and the specification then analysed against available assets, so that a deployment design system can determine an optimal configuration of components, and the Infrastructure Management system can then control one or more orchestration and control systems to deploy and configure the selected network and operational components.

Each candidate element of the service resolution can be analysed to determine whether sufficient resources are available to run the application on the specified device, and scanned for vulnerabilities, and if any vulnerabilities are identified that do not satisfy the specified security level but can be remedied by modifying the application, such modification is made to the application, which is re-assessed for suitability to meet the service application, and if the vulnerability is not capable of remedy the analysis process is suspended and an alternative configuration is analysed.

In response to user inputs specifying application elements, user devices on which the applications are to be deployed, and a user-defined security levels, a service design processor may be arranged to assemble the application elements into a proposed network, connected to the selected user device. A service level may also be specified to define protection required for the application when in service.

Analysis of service applications, devices and network links to determine protection required may be based on data from one or more of vulnerability scans, authentication data, previous history of use, and performance statistics. After installation of a containerised application, the steps of the process can be repeated in response to predetermined device, data centre and network link status conditions to determine if the configuration still meets the deployment policies and, if it does not, to select and deploy an alternative configuration.

Monitoring agents installed in the network resources and devices may provide status data on device, data centre and network link status.

In embodiments of the present invention, a deployed system may be continually monitored to ensure that the service operates within requirements. Should an incident such as a network attack or failure occur the system is re-analysed against the original requirements and re-configured or repaired to restore it to again meet the specified requirements.

An embodiment of the invention will be described by way of example, with reference to the drawings, in which:

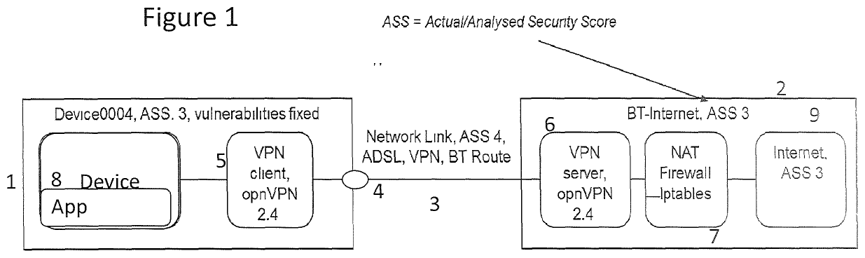

FIG. 1 is a high level diagram depicting the basic elements of a system to be deployed.

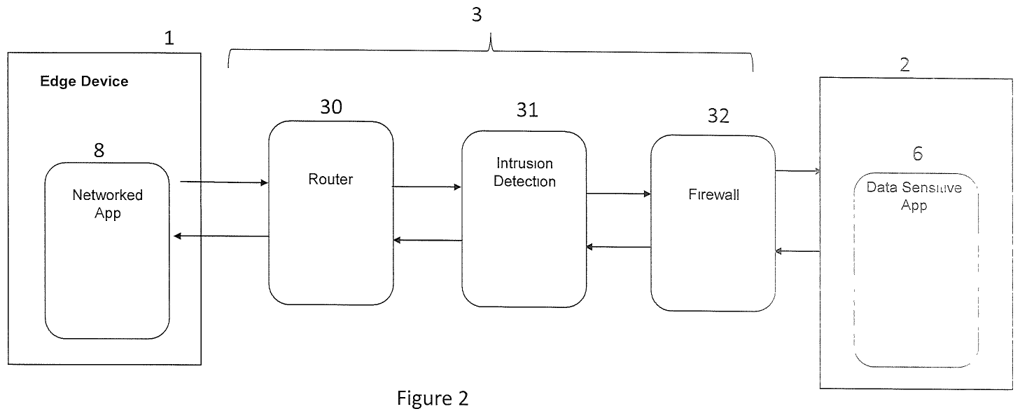

FIG. 2 depicts an example of a secure path between two applications

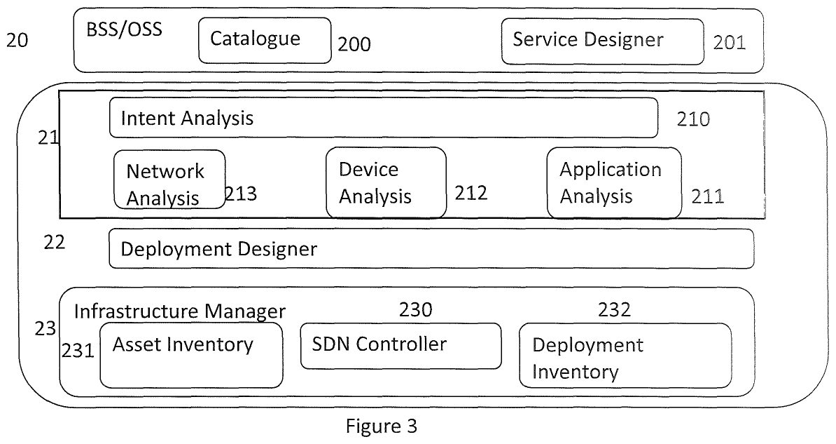

FIG. 3 depicts an architecture of a system for operating an application design process according to one embodiment of the invention

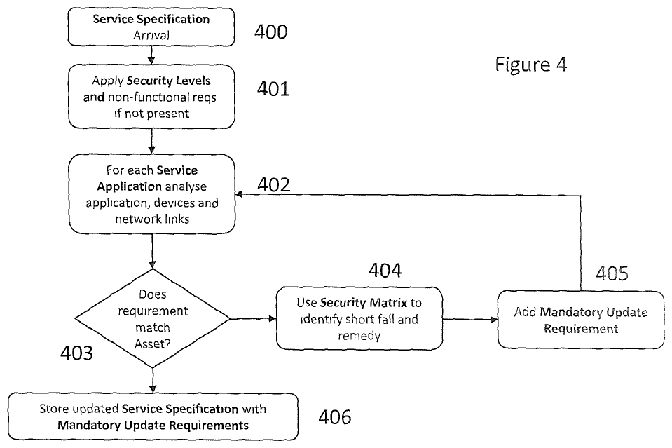

FIG. 4 is a flow diagram depicting a process operating according to the invention

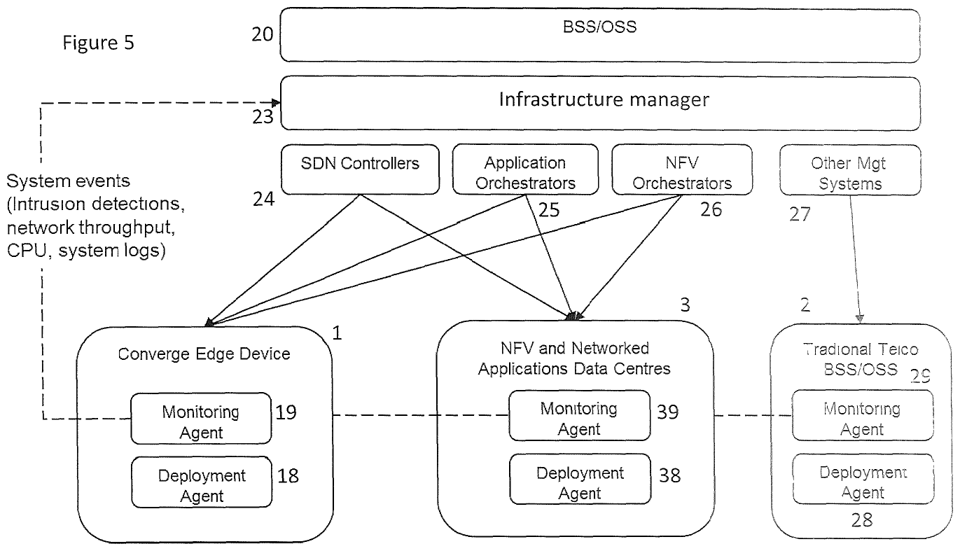

FIG. 5 is a more detailed depiction of the architecture of a system for operating a process according to one embodiment of the invention.

A number of components are used in this embodiment to enable the optimised orchestration of secure Network Function Virtualisation components and network-based applications.

Virtual Network Function components and Network-based Applications are treated as “service applications”, each having one or more addressable endpoints, commonly implemented as Virtual Machines or as containers, each having one or more interfaces for managing their configuration. Virtual Network Function components typically include routers, deep packet analysis, firewalls, DHCP and DNS servers. Network-based applications tend to include web servers, video servers, analytics and actual applications.

Customer edge devices include fixed or mobile user terminals, routers, switches and cloud-based components such as virtual machines, and provider edge devices. Complete cloud services can also be modelled as individual Virtual Machines.

Device Attributes may be identified through both static inventory data (configuration) and from installed agents installed on devices.

Networks are modelled on a link-by-link basis, each link being terminated with nodes, representing configurable devices hosting Network Function Virtualisation or application components. The terms “Node” and “Device” can therefore be used interchangeably. This approach allows users to request specific routes that may avoid certain locations, or for example, to include only links under the control of that user. Such an arrangement may be required to minimise costs paid to hosts of the external links, or to prevent interception by external parties of the network traffic itself, or of the address data relating to that traffic (which may itself be of value to an external party in discovering which network addresses are communicating with each other).

The high level architecture of a processor for operating the application design process is shown in FIG. 3. All the components of the system can run on a processing facility that can be hosted in the cloud, or on a general-purpose computing device. It is then available to an individual user via a graphical user interface, to allow users to specify their requirements.

There are three main components 20, 21, 22, 23. Firstly there is a Business and Operational Support System 20, in which a user's specification for end-to-end service is input in the form of applications, network links, devices and security constraints. Secondly, there is an analysis engine 21, where the user's requirements are analysed against existing and future assets. A deployment designer 22 determines the optimal location for components. Finally there is an Infrastructure Management system 23, which is the entity with the task of controlling the deployment of the application by interaction with further orchestration and control systems to configure network and computing assets.

In the Business and Operational Support System (BSS/OSS), the user selects applications from a catalogue 200 and a service designer 201 assembles them into a proposed network. The user can select the device on which the service is to be deployed. At this point the user can define the Security Level and other operational requirements, such as CPU usage or location constraints. However, these policies could also be enforced on a user basis, as will be described later.

The analysis engine 21 incorporates an analysis of the user's requirements and the network, device and application, deployment design, and finally the actual control of the orchestration to deliver the service.

Intent analysis (IA) 210 deals with coordinating the assessment of the user's Service specification against non-functional requirements such as application security, network availability, and device location etc. In certain cases the service specification will be specified (dependent upon capability of BSS/OSS tools) without security levels and non-functional specification. In this case the Intent analysis can use a generic service level and non-functional specification or an earlier user-defined example. The general flow is depicted in FIG. 4, which will be described later.

Individual elements of the analysis engine 21 cover service application analysis 211, device analysis 212 and network-link analysis 213, will now be discussed in turn. Each analysis results in a score, for example between 0 and 5.

Service Applications may exist as software libraries, virtual machines or containers. They are specified by name, unique identifier source, expected CPU usage, memory and storage. A service level is also specified that outlines what level of protection is required against potential security threats for the application when in service. Analysis of a service application, which may comprise one or more elements, is performed based on information such as vulnerability scans, provider of application, authentication by author, previous malware attack history, or provenance through prior use.

Device analysis assesses devices such as virtual machines, computers, mobile devices, “Internet of Things” devices. Attributes are assessed such as network connections (or potential for such connections), CPU requirements, hardware countermeasures such as Trusted Platform Modules (TPM), memory, storage, operating systems, locations and physical security. Analysis of such devices is based on information such as vulnerability scans of OS and existing applications, provider of operating systems and hardware, physical security and provenance through prior use

Network Link analysis describes the relationship between one service application and another. Network links have attributes such as mean, maximum, minimum, and current throughput, quality of service (best effort, guaranteed), availability (reliability), owner, route, location and physical security.

The automated design analysis stage uses a rule-based system to determine the optimal design of the Service specification and update requirements. These rules can be defined based on industry best practice, or heuristic algorithms, and they can be updated as standard approaches and short cuts are developed. For example, an application with a number of components may require full design analysis the first time it is deployed, but a template design can be constructed for future instantiations using the same application.

In the design stage the Service specification is adapted by identifying how the update requirements can be applied. In some cases there may well be multiple ways to design a service based on availability of resources and security threats, as will be discussed later.

The process can therefore be used to provide a specified security path and then enforce a requirement that all traffic relating to the application uses that path. For example, a user may want a networked application to be deployed on an existing edge device to access a data sensitive application running on another device. The user specifies the requirements that the link between the edge device and the sensitive application must be secure. As part of the Service Specification Analysis, the edge device can be analysed to determine what vulnerabilities exist in the host operating system, what security countermeasures already exist (firewall, intrusion detection), and what network connectivity is in place. The application can be scanned for vulnerabilities, with any critical vulnerabilities that cannot be fixed result in the analysis process being suspended or cancelled and the user alerted to the need to modify the specified requirements. Next, the existing network links are analysed to identify if they is secure enough based on the intended purpose. If no existing links are secure enough, it adds update requirements for each component that requires modification in order for a secure link to be created, either by adapting the route, or by adapting components on the originally-selected route. This will include setting up a secure route that traffic should take from the edge device to the location of the sensitive application.

The design stage generates a service set and specification of actions, which becomes an Orchestration Specification.

A typical use case is illustrated in FIG. 1, and in this case the customer has a requirement to install a web-application server 8 connected to the Internet 2. In this use case the user already has assets such as an edge device 1 that will host the web server, and a connection 3 to the Internet via an ADSL.

FIG. 2 shows the edge device 1 with the new application 8 deployed and the secure link 3 that has been created. The link 3 comprises of a router 30, intrusion detection 31 and firewall capabilities 32 which the traffic between the two applications 8, 9 is forced to go over.

Taking the example depicted in FIG. 1 and FIG. 2 for illustrative purposes, the design can be developed as follows.
1. The target device 1 is identified as capable of hosting a service application 8 but does not have vulnerability scanning or critical fixing, so this is added to the Orchestration Specification.
2. The service application 8 is also added to the Orchestration specification. Given that vulnerability scanning and fixing is already marked for the device no further action is required in this respect.
3. As a firewall is required, the Orchestration specification is updated to include a firewall, if not already present, and a link to the firewall from the service application is made. A new interface is created on the firewall representing the new endpoint of the service application.
4. If it is determined that there are insufficient resources, no existing firewall, or a firewall exists elsewhere, then the previous step may be applied at a later stage. Rules can be applied based on mapping an appropriate port for the firewall.
5. A network link is added to the Orchestration specification. In this example it is assumed the link 3 to the Internet is through a VPN that satisfies the security score, so this can be reused. If this is not the case the Orchestration specification is updated to configure a new link.
6. It may be necessary to instantiate a virtual firewall 32 in the edge device 1, along with the associated setting up of a route to the Internet from the device.

The Orchestration specification thus provides sufficient data for an orchestration system to set up the service. Using the same model the design stage can be used to update an existing orchestration specification to maintain and enforce a recommended security path meeting the service specification, in response to changes in security levels.

The process for selecting and installing the application will be described with reference to FIG. 4. The user specifies his requirements using a graphical or textual tool to create a description of a service or Service Speciation (Service specification). (Step 400).

The service is specified in terms that include:
Devices (e.g the user device 1)—machines that can be programmed and configured remotely
Network-Links (e.g the internet connection 3)—virtual or real connections between devices, that can be programmed and configured remotely, such as the virtual private network client 5 and server 6 managing that link
Endpoints (for example the interface 4 between the device 1 and the link 3)—the port or other point of attachment of a network link to a device
Service Applications 7, 8, 9—single or multiple applications that may be deployed on one or more devices.

The user additionally specifies a non-functional constraints for each component that includes capacity, version, CPU, network throughput, preferred device and security measures (step 401)

A typical Service specification could include: a target-Security-Score, a Service Description (e.g. Web server running on a host connected to the Internet), and specifications for the Service Applications, network links and devices to be used to provide the service, including memory, and security scoring, any intrusion detection features, CPU capacity etc. Shown in table 1 below is an example of a Security Matrix that can be used to determine the countermeasures required and upgrades infrastructure to support a service.

TABLE 1
Security Matrix

| | | Service Application | Network-Link |
|---|---|---|---|
| Security | Device Security | Security | Security |
| Level | Countermeasure | Countermeasure | Countermeasure |
| 5 | Secure Location, | DDOS, Restart, | VPN Encryption- |
| | Anti-tamper. | refactor under attack | 3 . . . |
| 4 | High Security | Firewall-Source | VPN Encryption-2, |
| | Location, Key Access, | Rejection, | Specified route, |
| | Provider Only, | Encrypted Data | physically secure |
| | Intrusion Detection. | | |
| 3 | Secure Location, | Vulnerability Fixing | VPN Encryption-1, |
| | Trusted Partner, | | Provider Only |
| | Vulnerability Fixing | | |
| 2 | Secured Location, | Firewall-Port | Trusted Partner |
| | No critical | Protection | |
| | vulnerabilities. | | |
| 1 | Secure Building, | Vulnerability | None |
| | Vulnerability | Scanning | |
| | Scanning | | |
| 0 | None | None | None |

Using this service specification as an example, the system would work at a high level as follows. Firstly the service application 8 which is to be installed is analysed to determine whether sufficient resources are available on the target device 1 to run the application. Dependent on the security level required, the application is scanned for vulnerabilities. Different elements can have different target scores, dependent on their perceived risk of exposure to threats. (FIG. 4 step 402)

Any critical vulnerabilities that do not satisfy the specified security level (step 403) are fixed (step 404) or, if they cannot be fixed, the analysis process is suspended or cancelled.

The target device 1 is also analysed to determine what vulnerabilities exist in the host operating system, what security countermeasures already exist (firewall 7, intrusion detection), and what network connectivity 3 is in place. Other static/inventory data about the locale, physical security of the device ownership and operation can also be analysed. The analysis is made by consulting a security matrix. A firewall, and vulnerability fixing features, can be added if necessary. For the sake of illustration, if the device is running with no critical vulnerabilities, operated by a trusted partner in a secure location then the device would be given a score of 2. A number of update requirements can be specified for vulnerability scanning and fixing of critical vulnerabilities (step 405).

The process is repeated for other elements of the system. If the application requires the device to be connected to a network, the network links 3 are also analysed. This is obviously not necessary in a standalone system. However, the existence of external links to the device 1, even if not used by the application to be installed, may affect its security score.

Each link and node in the network 3, 4, 5, 6 is analysed in turn. When the source 1 and destination 2 has connection in place (such as an existing VPN or MPLS service) it can be analysed as a single link. However, if the connection has links that can be influenced by updating intermediary nodes (routes or virtual network functions) the individual network links in the connection are assessed separately. Where a link is already in place and there is provision to extend it to the destination then it is marked as a candidate link. At the same time, factors such as encryption, routing, and ownership of network links are identified. In this example an ADSL link is identified but without any encryption or VPN, so a mandatory update requirement is added. Finally, if a link meets the above criteria and can be fixed then it is marked as a candidate link whilst any shortfalls are identified in mandatory update requirements.

Other assets or requested assets, such as an Internet Service Application 9 or the Internet itself 2 can be analysed and modified in the same way.

We now have a modified Service specification with Mandatory Update Requirements (MAR), and a number of candidate assets that can be used have been identified. Some assets, such as network connectivity or a suitable device, may not have been identified at this point.

The overall service has a target security score, which in this example is set at 3. The most appropriate service application has been identified and its security score analysed (at 2, for example). In order to raise its score to the target value, update requirements are set, for example Vulnerability-Scanning, Critical-Vulnerability-Fixing, and an NAT-Firewall.

Similarly, the service application is identified as the Internet, and an Analysed-Security-Score is identified for it. In this example we shall assume this meets the target security score so there are no security update requirements. However, a static-IP-Address has to be allocated.

In this example the network links to be used are analysed to have a security score of 2, against a target of 4 (as previously noted, different elements can have different target scores, dependent on their perceived risk of exposure to threats). In order to meet this requirement, updates may require that the network routing uses a specified route (e.g no links not under the control of the service provider, or all traffic to be within a virtual private network). Finally, the device 1 on which the application to run is assessed, and any update requirements identified such as Vulnerability Scanning and Critical Vulnerability Fixing.

The resulting service application is then re-assessed (step 402, 403) to determine whether it meets the service specification. This may not be the case if, for example, the modifications to the network routing result in an incompatibility with the modifications previously made to the target device. For example, a combination of configuration adaptations made to meet a network security requirement may result in a latency value which is outside specified limits. If this is the case the process is repeated (step 404, 405) until the specification meets all the requirements. The resulting service application is then stored (step 406) ready for delivery to the customer in the form depicted in FIG. 1, with the virtual private network client 5 installed on the device and a corresponding VPN server 6 selected in the internet, together with a suitable firewall 7.

A deployment designer 22 analyses the specified service application and retrieves data to create an Orchestration specification document from that specification. The Orchestration specification document is used by the Infrastructure Management system 23 to orchestrate the actual creation and deployment of application and network assets.

An orchestration specification document can be created using a rule engine as depicted in Table 2. For instance when a server is requested, then based on the conditions (suitability of the target device) a firewall can be installed on either the Target Device or the Upstream Device. Likewise once the application is deployed a static IP address can be created within the network.

TABLE 2
Orchestration Specification

| | | | | | |
|---|---|---|---|---|---|
| Con- | Status | Requested | Requested | Deployed | Requested |
| ditions | Target- | 3 | 3 | — | — |
| | Security- | | | | |
| | Score | | | | |
| | Mandatory | NAT- | NAT- | — | VPN |
| | Update | Firewall | Firewall | | required |
| | Target Device | Suitable | Un- | — | Suitable |
| | Resources | | suitable | | |
| | Orch spec'n? | Yes | Yes | — | — |
| Out- | Deployment | Install | Install | Allocate | Install |
| comes | Action | Iptables | Iptables | Static IF | VPN |
| | | Firewall | Firewall | address | client |
| | | | | | & server |
| | Deployment | Target | Upstream | Upstream | Target |
| | Location | Device | Device | Device | Device, |
| | | | | | Upstream |

The Orchestration specification document could take several forms, for example:
i) a pure high level design specification, leading to further interpretation by the Infrastructure Management system later.
ii) a single orchestration technology specification for a standard proprietary orchestrator.
iii) a composite form, whereby orchestration technology specific code elements may be included within a generic orchestration specification.

An orchestration specification flag allows the actual multiple decision logic to be replicated in the Orchestration specification to offer more flexibility at deployment time.

The Infrastructure Management system 23 comprises three main components. The first component is a controller 230 responsible for executing orchestration specifications against underlying technology specific management and orchestration platforms. The controller can be implemented in many ways, for example a scripting approach, in which the orchestration specification is based on a scripting language that can be simply run against a suitable shell, or node interpreter. An alternative implementation uses an interpretation engine, in which the controller is arranged to interpret the orchestration specification and to interact with lower management and orchestration systems.

The second component is an asset inventory 231, used to store basic information about devices, existing network links and service applications that are in place prior to the ordering phase. This registry includes management endpoints for controlling the assets.

The third component is a deployment inventory 232, used to record service specifications, Mandatory Update Requirement (MUR) and orchestration specification documents. The deployment inventory is also used to store the actual configuration that is created to satisfy the demand, and which entities and management systems were responsible for setting it up.

FIG. 5 shows the complete system. The Infrastructure Management system 23 interacts with a number of existing orchestration and network management systems 24, 25, 26, 27 to deploy services, using respective deployment agents 18, 28, 38 in the various devices and systems 1, 2, 3. At the same time monitoring agents 19, 29, 39 are installed in the various devices and systems 1, 2, 3 to provide a live view of device, data centre and network link status.

1. A method of deploying applications and virtualised network functions to meet a service specification having a specified security profile, in which a plurality of candidate configurations of network resources, devices, applications and functions are assessed for ability to meet the service specification, and in which a security analysis is performed of the candidate network configurations, devices and applications to be deployed to implement the service, one of the candidate configurations of network, devices, applications and functions is selected, and the network resources, devices, applications and functions are adapted to meet the specified security profile prior to deployment.

2. A method according to claim 1, in which after deployment the selected configuration is monitored to ensure that the system remains compliant with the service specification.

3. A method according to claim 2, wherein on detection of a network attack or failure a new security profile is generated, the configuration is re-analysed against the new security profile, and the configuration of network, devices and applications is modified to meet the new security profile.

4. A computer-implemented process for controlling a containerisation orchestrator to perform the steps of claim 1 by:
a. selecting a candidate application for containerised deployment to a device
b. retrieving application software for running the application
c. analysing the application software for vulnerabilities
d. analysing the selected container deployment configuration
e. assessing operational parameters of the device
f. comparing the operational parameters of the device and the container deployment configuration with vulnerabilities identified in the candidate application software, to determine if they are compatible with a predetermined risk score
g. if it is determined that the candidate application is not compatible with the risk score, re-assessing the candidate application for compatibility if adapted with an enhanced security provision, and
h. if such compatibility is identified, controlling the orchestrator to containerise and deploy the candidate application software on the device.

5. A process according to claim 4, wherein if compatibility is not identified, the orchestrator does not deploy the candidate application software and the analysis steps are repeated using a different candidate application.

6. A process according to claim 1, in which an Infrastructure Management system controls one or more orchestration and network management systems to deploy services using respective deployment agents in the network resources and devices.

7. A process according to claim 1, in which a user's specification for end-to-end service is input in the form of applications, network links, devices and security constraints, the specification is analysed against available assets, a deployment design system determines an optimal configuration the optimal configuration of components, and an Infrastructure Management system controls one or more orchestration and control systems to deploy and configure the selected network and operational components.

8. A method according to claim 7, in which each candidate element of the service resolution is analysed to determine whether sufficient resources are available to run the application on the selected device, and scanned for vulnerabilities, and if any vulnerabilities are identified that do not satisfy the specified security level but can be remedied by modifying the application, such modification is made to the application which is re-assessed for suitability to meet the service application, and if the vulnerability is not capable of remedy the analysis process is suspended and an alternative configuration is analysed.

9. A process according to claim 7, in which, in response to user inputs specifying application elements, user devices on which the applications are to be deployed, and a user-defined security levels, a service design processor assembles the application elements into a proposed network, connected to the selected user device

10. A process according to claim 9, wherein a service level is also specified to define protection required for the application when in service.

11. A process according to claim 10, wherein analysis of service applications, devices and network links to determine protection required is based on data from one or more of vulnerability scans, authentication data, previous history of use, and performance statistics.

12. A process according to claim 4, wherein, after installation of a containerised application, the steps of the process are repeated in response to predetermined device, data centre and network link status conditions to determine if the configuration still meets the deployment policies and, if it does not, to select and deploy an alternative configuration.

13. A process according to claim 8, in which monitoring agents installed in the network resources and devices provide status data on device, data centre and network link status.

14. A computer system including a processor and a memory storing computer program code for performing the steps of the process of claim 1.

15. A computer program element comprising computer program code to, when loaded into a computer system and executed thereon, cause the computer to perform the steps of a process as claimed in claim 1.
